(19) United States
(12) Patent Application Publication
(10) Pub. No.: US 2008/0098904 A1
(43) Pub. Date: May 1, 2008

(54) Sling for use in roasting food

(75) Inventor: Frederick Fouse, Manhattan Beach, CA (US)

Correspondence Address: EDWARD A SOKOLSKI, 3868 CARSON STREET, 105, TORRANCE, CA, 90503, US

(73) Assignee: WILLIAM BOUNDS, LTD

(21) Appl. No.: 11/543,342

(22) Filed: Oct. 4, 2006

(51) Int. Cl. A47J 37/10

(52) U.S. Cl. 99/425

(57) ABSTRACT

A sling fabricated of a high temperature flexible material such as silicone is used to support foodstuff such as a turkey for roasting and draining. The sling has a central portion with a relatively large area and narrower handle portions, which run in opposite directions from opposite sides of the central portion. The turkey or other foodstuff is wrapped in the central portion. The central portion has apertures formed therein. These apertures are surrounded by knobs, which raise the central portion off its support so that drainage through the holes is facilitated. A rack having a support with apertures for the foodstuff may be provided, this rack being attached to the handles so that it is supported by the sling and enables drainage in the oven and is removed with the turkey from the oven for drainage subsequent to roasting.

### BACKGROUND OF THE INVENTION

1. Field of the Invention

This invention relates to a flexible sling of a material, which can stand high temperature in which food such as a turkey can be supported in a heating device such as an oven or stove top for roasting. When the food has been roasted, the sling with the food in it is removed from the oven for drainage.

2. Description of the Related Art

Generally a turkey or other food is roasted in an oven or other heating medium by depositing it directly on a metal rack placed in the oven. When roasted, it must be removed with covered hands. This is rather inconvenient in that one's hands must be placed around the turkey, which is not always easy to do especially if the turkey is rather large, and also has the risk of burning one's fingers or arms. In addition, when removed from the oven, the turkey is often placed in a flat plate, which does not afford proper drainage of excess liquid on the turkey.

A cooking sling for use in supporting food for surface heating in a microwave oven is described in U.S. Pat. No. 4,820,893 issued on Apr. 11, 1989 to Mode. This device uses a collapsible package from a pair of sling enclosures contained in a box like walls. It does not have handles on the opposite sides for facilitating the placement of the slings in the oven or the removal from the oven. Further it has limited capacity in that it does not have a large centerpiece, which can be folded around food to hold it in place. In addition, there is no provision in this device for drainage.

### SUMMARY OF THE INVENTION

The device of the present invention is a sling fabricated of a high temperature flexible material such as silicone. The sling has a relatively small thickness and a relatively large area central portion and substantially narrower handle portions, which run from opposite sides of the central portion. A turkey or other foodstuff is wrapped in the central portion. To afford drainage, apertures are provided in the central portion. These apertures are surrounded by knobs, which raise the central portion so that drainage through the holes is facilitated. A rack having a support for the turkey with apertures may be provided, this rack being attached to the handles so that it supports the turkey to provide drainage in the oven and is removed with the turkey from the oven for drainage subsequent to roasting. The sling also has the advantage of keeping delicate foodstuff intact.

### DESCRIPTION OF THE DRAWINGS

FIG. 1 is a perspective exploded view of the device of the invention in the process of being used to drop foodstuff on a rack;

FIG. 2 is a cutaway section illustrating a handle of a preferred embodiment of the invention;

FIG. 3 is a top plan view of a preferred embodiment of the invention;

FIG. 4 is a cross sectional view taken along the plane indicated by 4-4 in FIG. 3;

FIG. 5 is a cross sectional view taken along the plane indicated by 5-5 in FIG. 3;

FIG. 6 is a cross sectional view of one of the knobs and apertures of the central portion of the preferred embodiment taken along the plane indicated by 6-6 in FIG. 2;

FIG. 7 is a top perspective view of a rack for use in conjunction with the preferred embodiment; and

FIG. 8 is a top perspective view of the preferred embodiment being used in combination with the rack of FIG. 7.

### DETAILED DESCRIPTION OF THE INVENTION

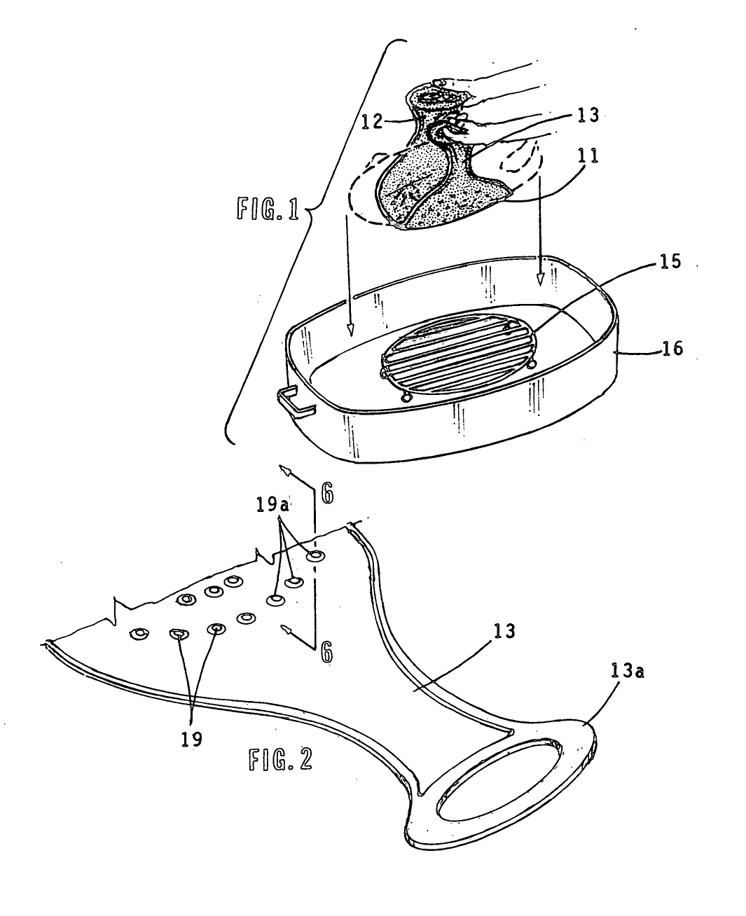

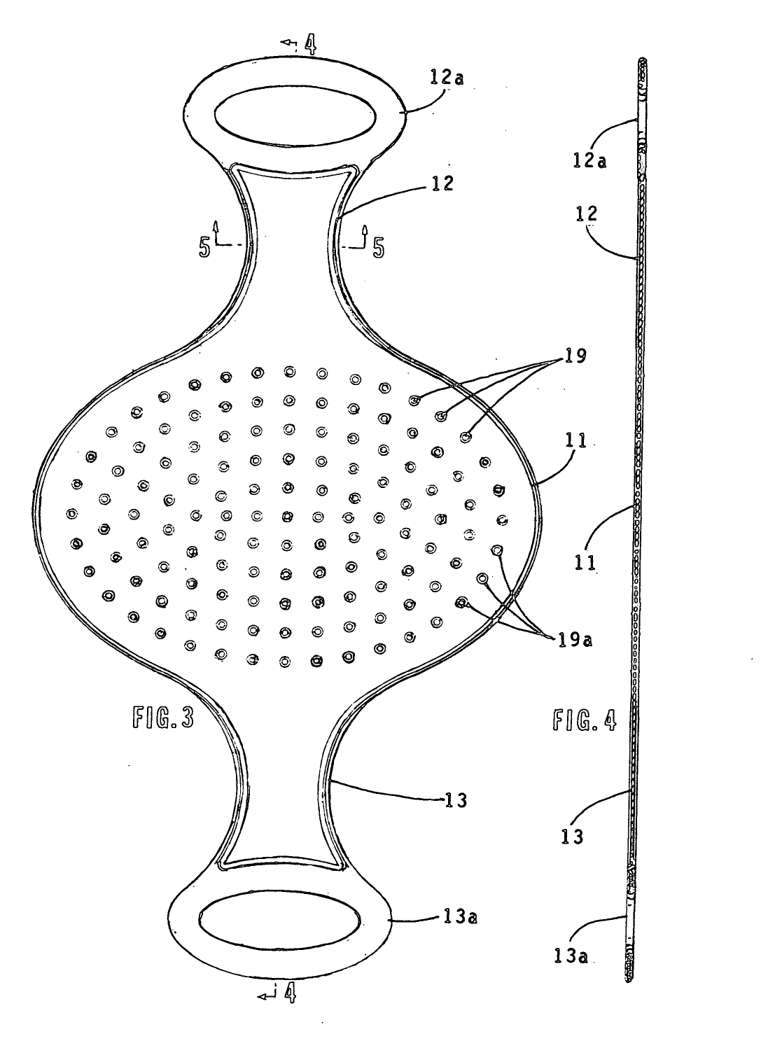

Referring particularly to FIGS. 1-6, a preferred embodiment of the sling of the invention is illustrated. The sling is fabricated of a flexible relatively thin piece of material capable of withstanding high temperatures of the order of 600 degrees F. It has been found that a material of silicone satisfies these requirements. The sling has a relatively wide area central portion 11 with arm portions 12 and 13 of relatively small width, which extend from the ends of the central portion in opposite directions. Apertured handles 12a and 13a are formed on the ends of each of the arms to enable manual lifting and lowering of the sling as shown in FIG. 1

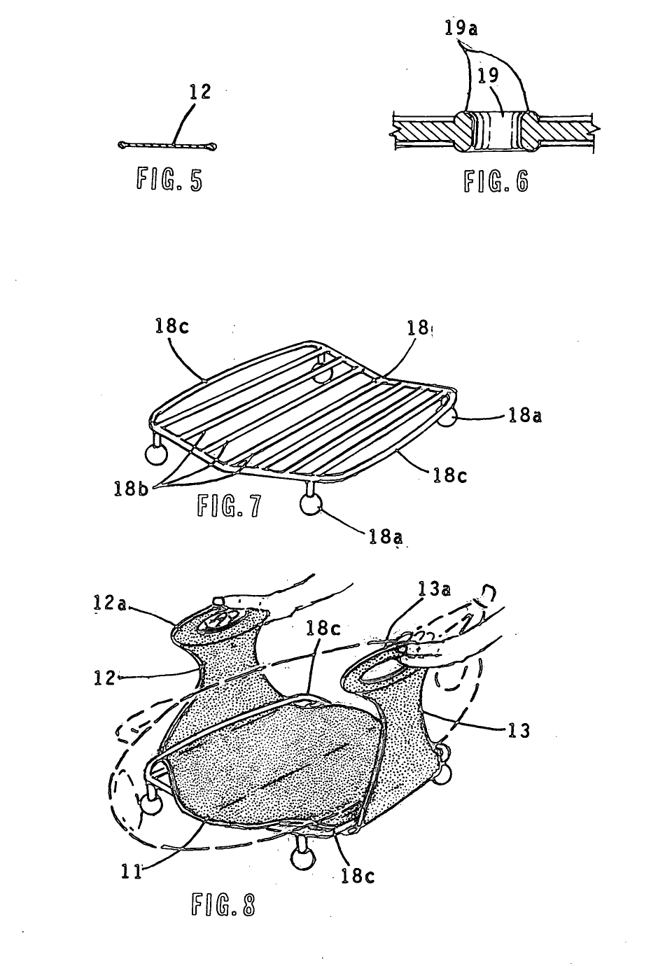

Apertures 13 are formed throughout the central portion 11 of the sling through which drainage of the foodstuff is achieved. Knobs 13a around each of apertures 13 extend from the bottom surface of the central portion. FIG. 6 is an enlarged cross sectional view illustrating such knobs. The knobs provide a stand off of the bottom surface of the central portion of the sling so that it could be placed on a flat surface in the oven or other heating medium or on a support rack employed when the sling is removed from the heating medium.

The sling with the turkey or other foodstuff contained therein after having been roasted in a heating medium such an oven can be lifted out of the oven and deposited on a rack 15 contained within pan 16 for drainage.

Referring now to FIGS. 7 and 8, a second embodiment of the invention is illustrated. Rack 18 has support feet 18a extending from its bottom and bars 18b running across the portion thereof. The end bars 18c form attachments through which the arms 12 and 13 are run. The sling is thus supported on rack 18 with the central portion abutting against bars 18. In this manner, the foodstuff can be roasted on the rack then removed from the rack for cooling down, drainage being provided both during roasting and cooling. With this embodiment, the foodstuff can be initially installed in the sling and the sling attached to the rack and retained in this configuration during both roasting and cooling.

While the invention has been described and illustrated in detail, it is to be understood that this is intended by way of illustration and example only and not by way of limitation, the spirit and scope of the invention being determined by the following claims.

I claim:

1. A sling for supporting foodstuff for roasting within a heating device and placing said foodstuff within said oven and removing it therefrom comprising:
A central portion having a relatively large area; and
handle portions extending from said central portion in opposite directions;
said central portion having a plurality of apertures formed therethrough;
said foodstuff being wrapped in said central portion;
said handles being used to place said foodstuff in said heating device and removing said foodstuff therefrom.

2. The sling of claim 1 and further including knobs surrounding said apertures at the outer ends thereof, said knobs standing said foodstuff off the surface of said oven to permit drainage of said foodstuff.

3. The sling of claim 1 wherein said sling is fabricated of silicone.

4. The sling of claim 1 and further including a rack for supporting said foodstuff, said rack having support bars spaced from each other between which liquid can pass, said rack further having openings at the opposite ends thereof through which the arms of said sling are fitted.

5. A flexible sling for supporting foodstuff for roasting in a heating device comprising:
a central portion having a relatively large area, said central portion having inner and outer surfaces, apertures being formed though said central portion, knobs being formed around said apertures on the outer surface thereof,
a pair of arm portions extending in opposite directions from said central portion, said arm portions having relatively small widths as compared with the width of said central portion; and
a rack having a top portion and a bottom support portion spaced from said top portion for supporting said central portion of said sling, said rack top portion having openings therein for permitting liquid to pass therethrough to the bottom portion of said rack, said rack further having apertures formed in each of the opposite ends thereof, each of the arm portions of said sling being fitted through a separate one of said rack apertures.
